(19) United States
(12) Patent Application Publication
(10) Pub. No.: US 2025/0162617 A1
(43) Pub. Date: May 22, 2025

(54) SYSTEMS AND METHODS FOR ALTERING VEHICLE FORM-FACTOR IN RESPONSE TO TRAFFIC CONDITIONS

(71) Applicant: Torc Robotics, Inc., Blacksburg, VA (US)

(72) Inventors: Joseph R. Fox-Rabinovitz, Blacksburg, VA (US); Akshay Pai Raikar, Blacksburg, VA (US); William Davis, Blacksburg, VA (US); Dakota James Hebert, Blacksburg, VA (US); Justin Yurkanin, Blacksburg, VA (US)

(21) Appl. No.: 18/512,828

(22) Filed: Nov. 17, 2023

(51) Int. Cl. B60W 60/00

(52) U.S. Cl. CPC B60W 60/0018; B60W 2510/0638

(57) ABSTRACT

A system for altering form factor of an autonomous vehicle is provided. The system includes a movable member for mounting on the autonomous vehicle. The movable member is configured to move between a closed position and an extended position. The system further includes an actuator coupled to the movable member and configured to move the movable member between the closed position and the extended position. The system further includes a processing system in communication with the actuator. The processing system is configured to receive, from at least one sensor of the autonomous vehicle, at least one sensor signal, determine to move the movable member from the closed position to the extended position based on the at least one sensor signal, and control the actuator to move the movable member from the closed position to the extended position based on the determination.

### TECHNICAL FIELD

The field of the disclosure relates generally to autonomous vehicles and, more specifically, autonomous vehicles configured to change form-factor in response to traffic conditions.

### BACKGROUND OF THE INVENTION

Trucks, due to their size, are generally less maneuverable than smaller vehicles. For example, trucks may need to greatly reduce their speed and/or require more space in order to make sharp turns or change lanes. Other drivers may try to take advantage of these situations by attempting to pass trucks inappropriately, such as by passing the truck using a road shoulder. This situation is problematic, as the vehicle passing the truck inappropriately may collide with the truck or an unseen vehicle. Further, in cases in which the truck is an autonomous vehicle, there may be no personnel such as truck drivers or pilot car drivers present that may direct traffic when the truck is making a turn, and the autonomous vehicle may have difficulty responding to vehicles behaving outside the normal rules of traffic. A system that enables a truck to safely respond to these traffic conditions is therefore desirable.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a system for altering form factor of an autonomous vehicle is provided. The system includes a movable member for mounting on the autonomous vehicle. The movable member is configured to move between a closed position and an extended position, wherein when in the extended position, the movable member extends in a transverse direction relative to forward motion of the autonomous vehicle. The system further includes an actuator coupled to the movable member and configured to move the movable member between the closed position and the extended position. The system further includes a processing system in communication with the actuator. The processing system is configured to receive, from at least one sensor of the autonomous vehicle, at least one sensor signal, determine to move the movable member from the closed position to the extended position based on the at least one sensor signal, and control the actuator to move the movable member from the closed position to the extended position based on the determination.

In another aspect, a method for altering form factor of an autonomous vehicle is provided. The method includes receiving, from at least one sensor of the autonomous vehicle, at least one sensor signal, determining to move a movable member from a closed position to an extended position based on the at least one sensor signal, the movable member mounted on the autonomous vehicle, wherein when in the extended position, the movable member extends in a transverse direction relative to forward motion of the autonomous vehicle, and controlling an actuator coupled to the movable member to move the movable member from the closed position to the extended position based on the determination.

In yet another aspect, an processing system for altering form factor of an autonomous vehicle is provided. The processing system includes a processor configured to receive, from at least one sensor of the autonomous vehicle, at least one sensor signal, determine to move a movable member from a closed position to an extended position based on the at least one sensor signal, the movable member mounted on the autonomous vehicle, wherein when in the extended position, the movable member extends in a transverse direction relative to forward motion of the autonomous vehicle, and control an actuator in communication with the processing system and coupled to the movable member to move the movable member from the closed position to the extended position based on the determination.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a block diagram illustrating an example system for altering vehicle form factor according to an embodiment of the present disclosure;

FIG. 2 is a block diagram of an example autonomous vehicle for use in the system depicted in FIG. 1;

FIG. 3 is a flow chart illustrating an example method for altering vehicle form factor that may be performed by the system shown in FIG. 1;

FIG. 4A is a perspective view illustrating an example embodiment of the system depicted in FIG. 1 including movable members implemented as flaps;

FIG. 4B is another perspective view of the example embodiment shown in FIG. 4A;

FIG. 5 is a perspective view illustrating another example embodiment of the system depicted in FIG. 1 including movable members are implemented as booms;

FIG. 6 illustrates a first example case in which the system shown in FIG. 1 may be utilized;

FIG. 7 illustrates a second example case in which the system shown in FIG. 1 may be utilized;

FIG. 8 illustrates a third example case in which the system shown in FIG. 1 may be utilized;

FIG. 9 illustrates a fourth example case in which the system shown in FIG. 1 may be utilized; and

FIG. 10 is another flow chart illustrating an example method for altering vehicle form factor that may be performed by the system shown in FIG. 1.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

As used herein, the term “processing system” refers to one of or any group of the electronic hardware components present on, or in communication with a vehicle responsible for executing processing functions. These components may include, but are not limited to, an autonomy computing system, electronic control module or electronic control unit, a controller, and/or any other individual processing devices present on the vehicle and/or capable of communicating with components present on the vehicle.

Embodiments of the disclosed system alter form factor of an autonomous vehicle (AV). The disclosed system includes one or more movable members for mounting on the autonomous vehicle. The movable members may include, for example, flaps or booms. The movable members are configured to move (e.g., rotate or telescopically slide) between a closed position and an extended position. When in the extended position, the movable members extend in a transverse direction relative to forward motion of the autonomous vehicle. Accordingly, when extended, the movable members may prevent other vehicles from passing the AV and/or guide other vehicles to pass the AV at a safe distance. The system further includes an actuator (e.g., a motor and/or hydraulic system) configured to move the movable member between the closed position and the extended position.

The system further includes a processing system, which is configured to receive, from at least one sensor of the AV, at least one sensor signal. The processing system is further configured to determine to move the movable member from the closed position to the extended position based on the at least one sensor signal. For example, the processing system may determine whether the AV is engaging in a vehicle operation (e.g., a turn, merge, or lane change) where it would be appropriate or helpful to extend the movable members, and whether it is physically feasible to extend the movable members based on a speed of the AV and/or presence of other objects around the AV. The processing system is further configured to control the actuator to move the movable member from the closed position to the extended position based on the determination. In some embodiments, the actuators may be controlled by a stand-alone processor, rather than by processing system that performs other vehicle control functions.

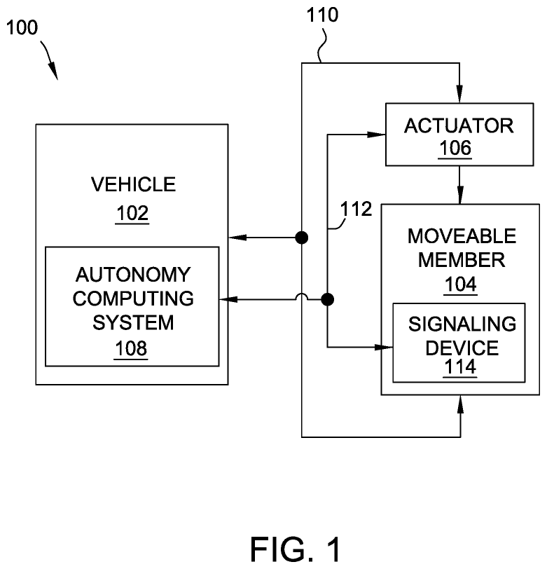

FIG. 1 is a block diagram illustrating an example system 100 for altering vehicle form factor, for example, in response to traffic conditions. System 100 includes an autonomous vehicle (AV) 102, one or more movable members 104, and one or more actuators 106. In the example embodiment, movable members 104 are mounted on or otherwise attached to AV 102, and are each movable between a first position and second position. In the first, or “closed,” position, movable members 104 do not substantially extend past a body of AV 102, such that movable members 104 do not substantially affect a form factor of AV 102. For example, in the closed position, movable members may lie flush against the body of AV 102 and/or be positioned within the body of AV 102. In the second, or “extended,” position, movable members 104 extend from the body of AV 102. For example, movable members 104 may extend in a horizontal or transverse direction from a side of AV 102. As used herein, the term “transverse direction” refers to a range of directions close to 90 degrees relative to a longitudinal axis, or a forward or backward direction of motion, of AV 102, such as a range between 85 and 90 degrees, between 80 and 90 degrees, between 45 and 90 degrees, or greater than 90 degrees relative to a forward or backward direction of motion of AV 102. While in the extended position, movable members 104 increase a combined width of AV 102 and movable members 104, which may in some cases discourage or prevent other vehicles from passing AV 102.

Movable members 104 include a mechanism that enables movable members 104 to be moved between the closed position and the extended position. In one example, this mechanism includes one or more hinges, such that movable members 104 can swing between the closed position, in which movable members 104 are substantially flush with the body of AV 102, and the extended position. In another example, movable members 104 slide and/or extend telescopically between the closed position within the body of AV 102 to the extended position. In other examples, movable members may utilize another extension and retraction mechanism such as, for example, scissor mechanisms, springs, folding and unfolding like a fan, rolling and unrolling, rack and pinion, rope/chain and pully system, and/or other such mechanisms. In various embodiments, movable members 104 may be implemented as booms, flaps, and/or other shapes, as described in further detail below. While two movable members 104 are illustrated, system 100 may include any number of movable members 104. Additionally, while generally described herein as being configured to extend from the sides of AV 102, it should be understood that movable members, when in the extended position, may be configured to extend forward, rearward, or in any other direction from AV 102.

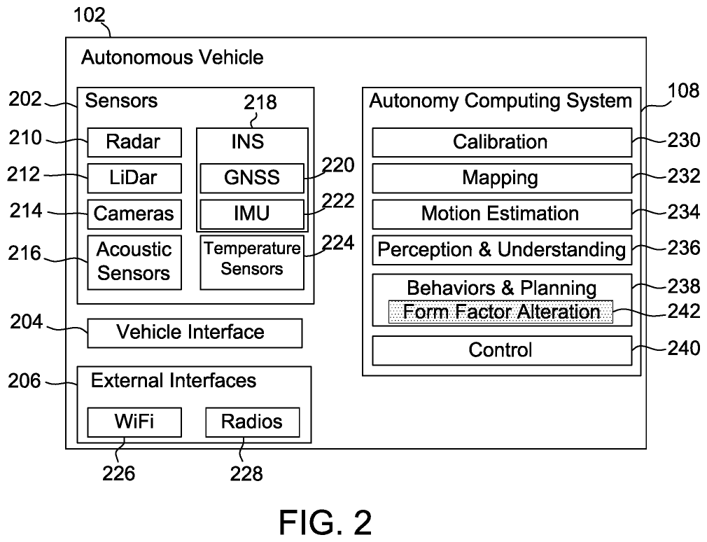

In the example embodiment, actuators 106 are configured to move respective movable members 104 between the closed position and extended position. In some embodiments, actuators 106 include an electromechanical device, such as a servomotor. Additionally, or alternatively, one or more of actuators 106 may include another type of device capable of moving movable members 104 such as a hydraulic or pneumatic device. Actuators 106 are configured to respond to control signals received from an autonomy computing system 108 configured to execute a form factor alteration module 242 (shown in FIG. 2) of AV 102 controlling actuators 106 to move movable members 104 to the extended position or closed position. In embodiments in which system 100 includes multiple movable members 104 and actuators 106, each actuator 106 can be controlled independently, such that at a given time, some movable members 104 may be in the closed position while other movable members 104 may be in the extended position.

In some embodiments, movable members 104 and/or actuators 106 are integrated components of AV 102 or a trailer coupled to AV 102. Alternatively, movable members 104 and actuators 106 may be a stand-alone system that can be attached to AV 102 or a trailer coupled to AV 102. In such embodiments, movable members 104 and/or actuators 106 include power couplings 110 and communication couplings 112 through which movable members 104 and/or actuators 106 can receive power and communication signals from AV 102. The communication coupling 112 may be a wired (e.g., controller area network (CAN), Ethernet, serial, pulse width modulation (PWM), etc.) or wireless (e.g., Bluetooth, near-field communication (NFC), Wi-Fi, etc.) coupling.

In some embodiments, system 100 further includes signaling devices 114, which are mounted on movable members 104 such that when movable members 104 are extended, signaling devices are visible to other vehicles. In some embodiments, signaling devices 114 include passive devices such as reflective tape wording, and/or other signage. In some embodiments, signaling devices include active devices such as flashing or cascading lights and/or display screens (e.g., light emitting diode (LED) arrays, liquid crystal display (LCD) screens, and/or electronic ink), which may be used to display caution or instructional messages to other vehicles. In some such embodiments, the displayed messages may be selected, based on a current condition of AV 102 (which vehicle operation AV 102 is performing and/or potentially hazardous road conditions identified by AV 102), from a library of messages by autonomy computing system 108 and transmitted to signaling devices 114 via communication couplings 112 for display. In some embodiments, signaling devices receive power from AV 102 via power couplings 110.

FIG. 2 is a block diagram of one embodiment of AV 102. In the example embodiment, AV 102 includes autonomy computing system 108, sensors 202, a vehicle interface 204, and external interfaces 206.

In the example embodiment, sensors 202 include various sensors such as, for example, radio detection and ranging (RADAR) sensors 210, light detection and ranging (LiDAR) sensors 212, cameras 214, acoustic sensors 216, inertial navigation system (INS) 218, which includes a global navigation satellite system (GNSS) receiver 220 and an inertial measurement unit (IMU) 222, and/or temperature sensors 224. Other sensors 202 not shown in FIG. 2 may include, for example, acoustic (e.g., ultrasound), internal vehicle sensors, meteorological sensors, and/or other types of sensors. Sensors 202 generate respective output signals based on detected physical conditions of AV 102 and its proximity. As described in further detail below, these signals may be used by autonomy computing system 108 to determine how to control operation of AV 102.

Cameras 214 are configured to capture images of the environment surrounding AV 102 in any aspect or field of view (FOV). The FOV can have any angle or aspect such that images of the areas ahead of, to the side, behind, above, and/or below AV 102 may be captured. In some embodiments, the FOV may be limited to particular areas around AV 102 (e.g., forward of AV 102, to the sides of AV 102, etc.) or may surround 360 degrees of AV 102. In some embodiments, AV 102 includes multiple cameras 214 and the images from each of the multiple cameras 214 may be stitched or combined to generate a visual representation of the multiple cameras' fields of view, which may be used to, for example, generate a bird's eye view of the environment surrounding AV 102. In some embodiments, the image data generated by cameras 214 may be sent to autonomy computing system 108 and/or other aspects of AV 102 and this image data may include AV 102 or a generated representation of AV 102. In some embodiments, one or more systems or components of AV 102 may overlay labels to the features depicted in the image data, such as on a raster layer or other semantic layer of a high-definition (HD) map.

LiDAR sensors 212 generally include a laser generator and a detector that send and receive a LiDAR signal. The LiDAR signal can be emitted and received from any direction such that LiDAR point clouds (or “LiDAR images”) of the areas ahead of, to the side, behind, above, or below AV 102 can be captured and represented in the LiDAR point clouds. In some embodiments, AV 102 includes multiple LiDAR lasers and LiDAR sensors 212 and the LiDAR point clouds from each of the multiple LiDAR sensors 212 may be stitched or combined to generate a LiDAR-based representation of the area in the field of view of the LiDAR signal(s). In some embodiments, the LiDAR point cloud(s) generated by the LiDAR sensors and sent to autonomy computing system 108 and other aspects of AV 102 may include a representation of and/or other data relating to AV 102, such as a location of AV 102 with respect to other detected objects. In some embodiments, the system inputs from cameras 214 and the LiDAR sensors 212 may be fused or used in combination to determine conditions (e.g., locations of other objects) around AV 102.

GNSS receiver 220 is positioned on AV 102 and may be configured to determine a location of AV 102, which it may embody as GNSS data, as described herein. GNSS receiver 220 may be configured to receive one or more signals from a global navigation satellite system (e.g., GPS constellation) to localize AV 102 via geolocation. In some embodiments, GNSS receiver 220 may provide an input to or be configured to interact with, update, or otherwise utilize one or more digital maps, such as an HD map (e.g., in a raster layer or other semantic map). In some embodiments, AV 102 is configured to receive updates from an external network (e.g., a cellular network). The updates may include one or more of position data (e.g., serving as an alternative or supplement to GNSS data), speed/direction data, orientation or attitude data, traffic data, weather data, or other types of data about AV 102 and its environment.

IMU 222 is an electronic device that measures and reports one or more features regarding the motion of AV 102. For example, IMU 222 may measure a velocity, acceleration, angular rate, and or an orientation of AV 102 or one or more of its individual components using a combination of accelerometers, gyroscopes, and/or magnetometers. IMU 222 may detect linear acceleration using one or more accelerometers and rotational rate using one or more gyroscopes and attitude information from one or more magnetometers. In some embodiments, IMU 222 may be communicatively coupled to one or more other systems, for example, GNSS receiver 220 and may provide an input to and receive an output from GNSS receiver 220.

In the example embodiment, vehicle interface 204 is configured, for example, to send one or more signals to the various aspects of AV 102 that actually control the motion of AV 102 (e.g., engine, throttle, steering wheel, brakes, etc.) and/or other components, such as actuators 106.

In the example embodiment, external interfaces 206 are configured to enable AV 102 to communicate with an external network via, for example, a wired and/or wireless connection, such as WiFi 226 and/or other radios 228. In embodiments including a wireless connection, the connection may be a wireless communication signal (e.g., Wi-Fi, cellular, LTE, 5g, Bluetooth, etc.). However, in some embodiments, external interfaces 206 may be configured to communicate with an external network via a wired connection, such as, for example, during testing of AV 102 and/or when downloading mission data after completion of a trip. The connection(s) may be used to download and install various lines of code in the form of digital files (e.g., HD maps), executable programs (e.g., navigation programs), and other computer-readable code that may be used by AV 102 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, AV 102 may deploy with all of the data it needs to complete a mission (e.g., perception, localization, and mission planning) and may not utilize a wireless connection or other connection while underway.

In the example embodiment, autonomy computing system 108 is implemented by one or more processors and/or memory devices of AV 102. Autonomy computing system 108 includes modules, which may be hardware components (e.g., processors or other circuits) and/or software components (e.g., computer applications or processes executable by autonomy computing system 108), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, and a control module 240.

In the example embodiment, behaviors and planning module 238 includes a form factor alteration module 242. Form factor alteration module 242 is configured to determine, based on sensor signals received from sensors 202, motion estimation module 234, perception and understanding module 236, and/or behaviors and planning module 238 and predefined rules, when to control actuators 106 to move movable members 104 to the closed position or the extended position. The predefined rules may include (i) situations under which extending movable members 104 should be considered and (ii) physical conditions under which it is feasible to extend movable members 104. Examples of situations in which extending movable members 104 should be considered include, as described in further detail below, turning, merging, lane changes, and/or slow traffic conditions. Form factor alteration module 242 is configured to determine at least one of these situations is present based on data received from other modules of autonomy computing system 108 and/or sensors 202. Examples of physical conditions that may affect whether it is feasible to extend movable members 104 include a speed of AV 102 (i.e., movable members 104 may not be extended if AV 102 is traveling above or below a threshold speed) or whether an external object is blocking or on course to block movable members 104 from extending. In embodiments in which multiple movable members 104 are present, form factor alteration module 242 may perform this determination separately for each movable member 104.

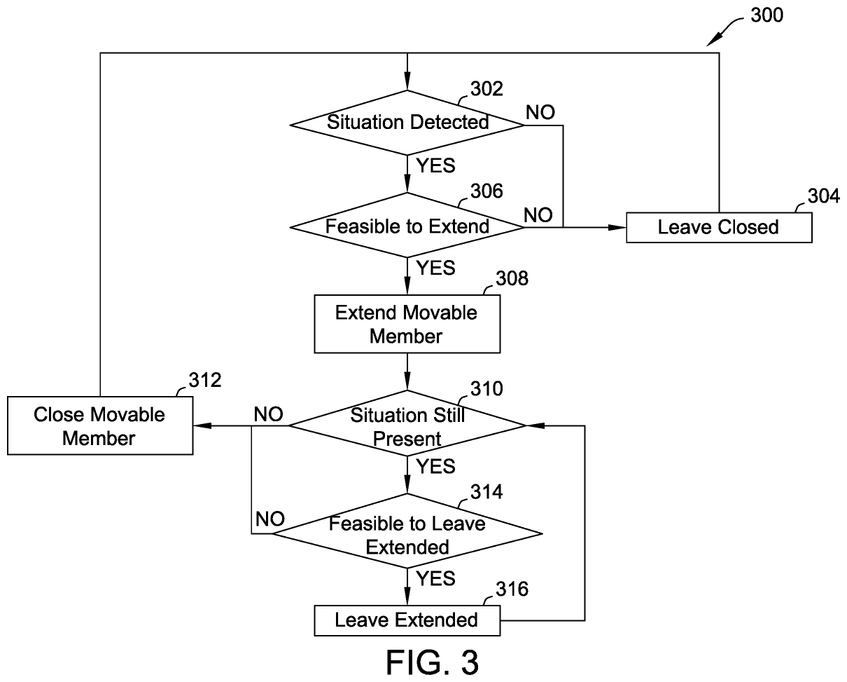

FIG. 3 is a flowchart illustrating an example method 300 for determining to extend or close movable members 104. Form factor alteration module 242 determines 302 whether AV 102 is in a situation where it would be appropriate to extend movable members 104. For example, AV 102 may be planning to make a wide turn, and may extend movable members 104 to prevent other vehicles from cutting AV 102 off during the turn. In another example, AV 102 may be planning on changing lanes, and may extend movable members 104 to prevent other vehicles from moving into the lane AV 102 is targeting. If no such situation is present, form factor alteration module 242 controls 304 actuators 106 to keep movable members 104 in the closed position (e.g., by actively sending an instruction or passively by not sending an instruction to move).

If a situation where it would be appropriate to extend movable members 104 occurs, form factor alteration module 242 determines 306 whether it is feasible to extend movable members 104. For example, form factor alteration module 242 may determine it is not feasible to extend movable members 104 because AV 102 is moving too quickly (e.g., above a predefined speed threshold) or if a vehicle or other object is blocking or on course to block movable members 104. In some embodiments, form factor alteration module 242 may utilize signals or data provided by sensors 202 or the modules of autonomy computing system 108 to determine whether it is feasible to extend movable members 104. If it is not feasible to extend movable members 104, form factor alteration module 242 controls 304 actuators 106 to keep movable members 104 in the closed position.

If form factor alteration module 242 determines 306 it is feasible to extend movable members 104, form factor alteration module 242 controls 308 actuators 106 to extend movable members 104. While extended, form factor alteration module 242 determines 310 whether the situation where it would be appropriate to extend movable members 104 is still present, for example, by determining whether an expected amount of time associated with the situation has expired and/or periodically determining a current status of the situation. If the situation is no longer present, form factor alteration module 242 controls 312 actuators 106 to move movable members 104 to the closed position. If the situation is still present, form factor alteration module 242 determines 314 whether it is still feasible to leave movable members 104 extended based on current or expected physical conditions. If it is not feasible to leave movable members 104 extended, form factor alteration module 242 controls 312 actuators 106 to move movable members 104 to the closed position. If it is feasible to leave movable members 104 in the extended position, form factor alteration module 242 controls 316 actuators 106 to leave movable members 104 in the extended position.

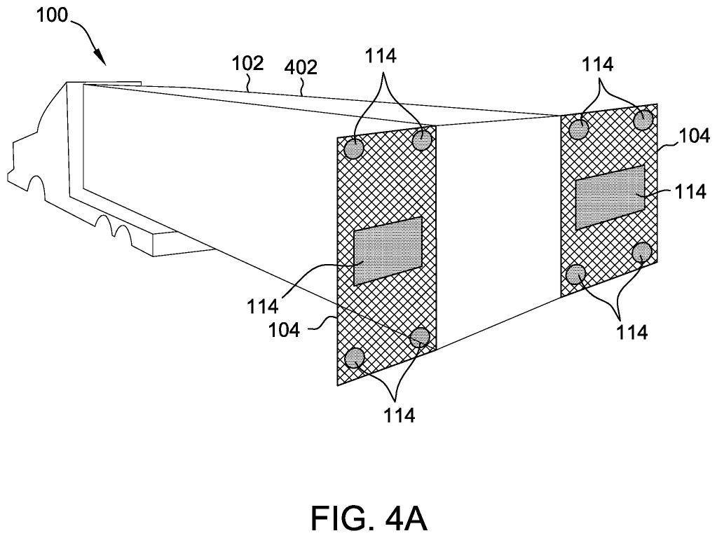

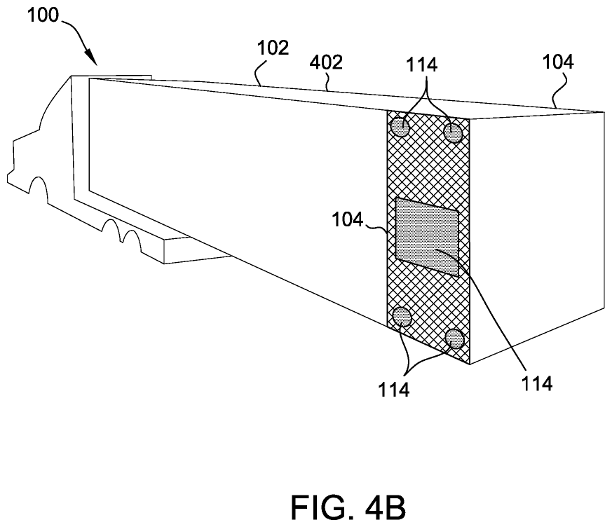

FIGS. 4A and 4B illustrate an example embodiment of system 100 in which movable members 104 are implemented as flaps mounted on a trailer 402 of AV 102. FIG. 4A depicts movable members 104 in the extended position, and FIG. 4B depicts movable members 104 in the closed position. As shown in FIGS. 4A and 4B, when implemented as flaps, movable members 104 may include a mesh material, which reduces an aerodynamic profile and weight of movable members 104 and enables some degree of visibility through the flaps. In some embodiments, other aspects of movable members 104, such as shape, form factor, extension and retraction mechanism, and/or position and orientation on or with respect to AV 102, are selected to reduce an aerodynamic profile of movable members 104. As shown in FIGS. 4A and 4B, movable members 104 include signaling devices 114, which may include, for example, lights or LCD screens. In some embodiments, signaling devices 114 are implemented as an array of LEDs, which may be individually controlled to display patterns and/or messages. Signaling devices 114 may be controlled by local processing components of movable members 104, by components of AV 102, or by some combination thereof. While depicted in FIGS. 4A and 4B as located at a rear of a trailer 402 of AV 102, movable members 104 may be positioned at any suitable location on AV 102.

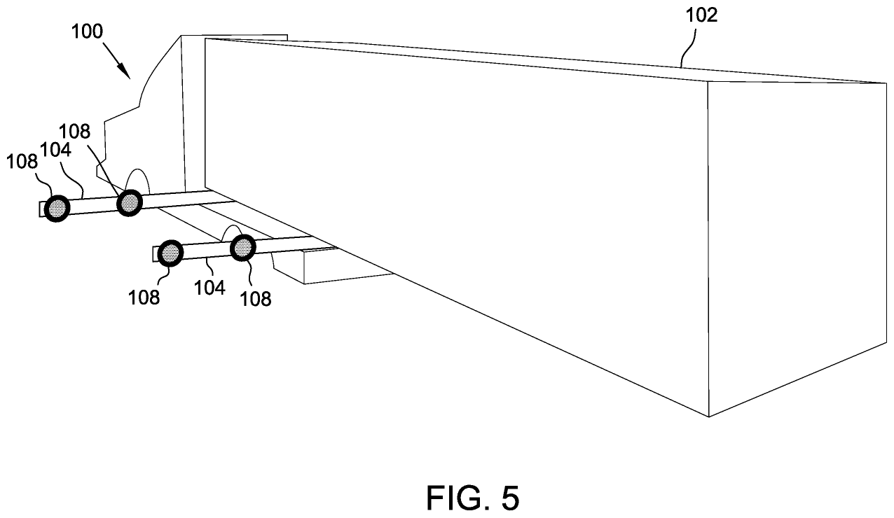

FIG. 5 illustrates an example embodiment of system 100 in which movable members 104 are implemented as booms, with movable members 104 being depicted in the extended position. As shown in FIG. 5, movable members 104 may include signaling devices 114 when implemented as booms. While depicted in FIG. 5 as located at a front of a trailer 402 of AV 102, movable members 104 may be positioned at any suitable location on AV 102. While movable members 104 are generally described herein as being positioned, when extended, to physically guide or prevent traffic from moving to close to AV 102, in some embodiments, movable members 104 may not act as a physical barrier to all types of traffic (e.g., booms extending laterally from the top of the cab, which may in some cases obstruct other tractor trailers, but not smaller traffic vehicles).

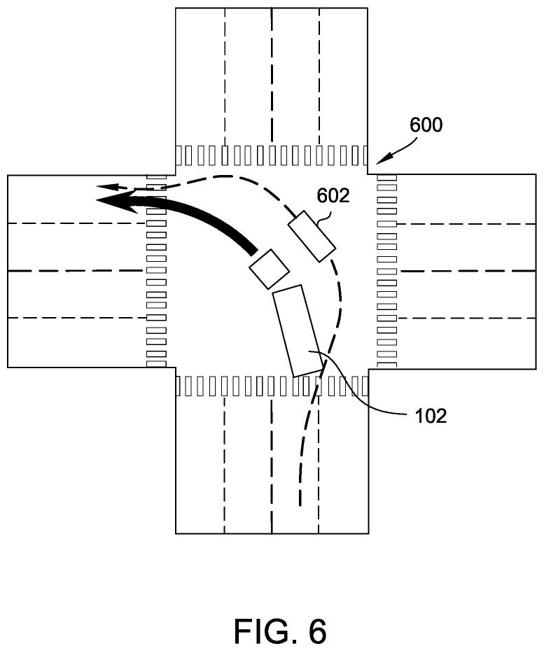

FIG. 6 illustrates a first example case in which movable members 104 may be utilized. In the first example case, AV 102 is attempting to make a left turn at an intersection 600. Because AV 102, as depicted, is a tractor trailer, AV 102 needs to make the turn at a relatively low speed and a wider turning radius compared to smaller vehicles. A coexistent vehicle 602 may attempt to take advantage of the low speed of AV 102 by passing AV 102 on the right, which may prevent AV 102 from fully executing the turn. AV 102 may extend movable members 104 from a right side of AV 102, which may prevent coexistent vehicle 602 from passing AV 102 on the right. AV 102 may similarly extend movable members 104 from a left side of AV 102 to prevent other vehicles from passing on the left during the turn operation. In the first example case, AV 102 may be configured to extend movable members 104 only after beginning the turn operation and close movable members 104 promptly after the turn operation has been completed, so that movable members 104 do not block legitimate traffic, and the amount of extension of moveable members 104 might be controlled throughout the turn to account for the variable amount of blockage required by AV 102.

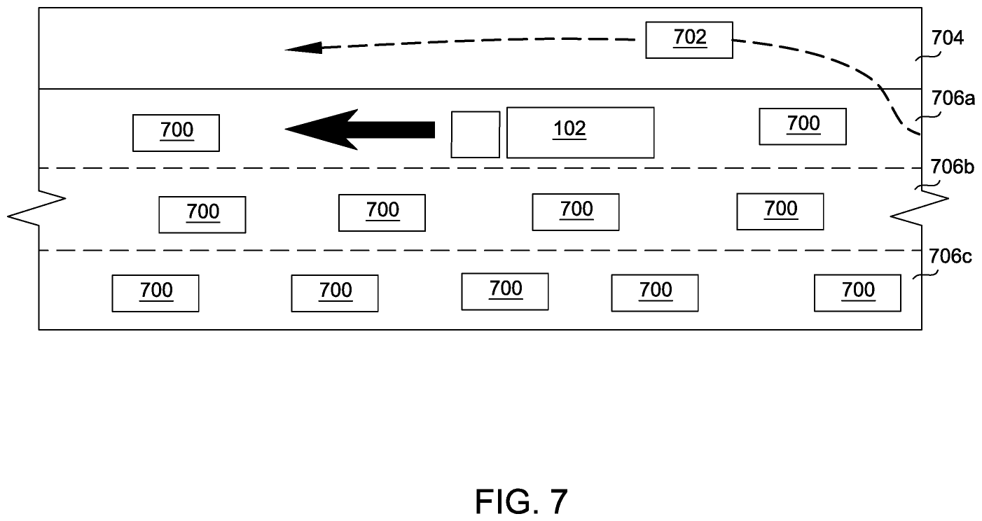

FIG. 7 illustrates a second example case in which movable members 104 may be utilized. In the second example case, AV 102 is traveling in slow traffic including other vehicles 700, and a coexistent vehicle 702 may attempt to pass the slow traffic on a shoulder 704 by traveling outside travel lanes 706a-706c, which may increase a likelihood of a collision and/or prevent vehicles legitimately traveling on the shoulder such as emergency response vehicles from reaching their target. AV 102 may extend movable members 104 from, for example, a right side of AV 102, which may prevent coexistent vehicle 702 from passing AV 102 on the shoulder. In the second example, AV 102 is configured to only extend movable members 104 when conditions indicate it is safe to do so. For example, AV 102 may only extend movable members 104 if AV 102 is traveling at or under a maximum speed threshold and/or if no objects and/or vehicles are currently detected in the shoulder.

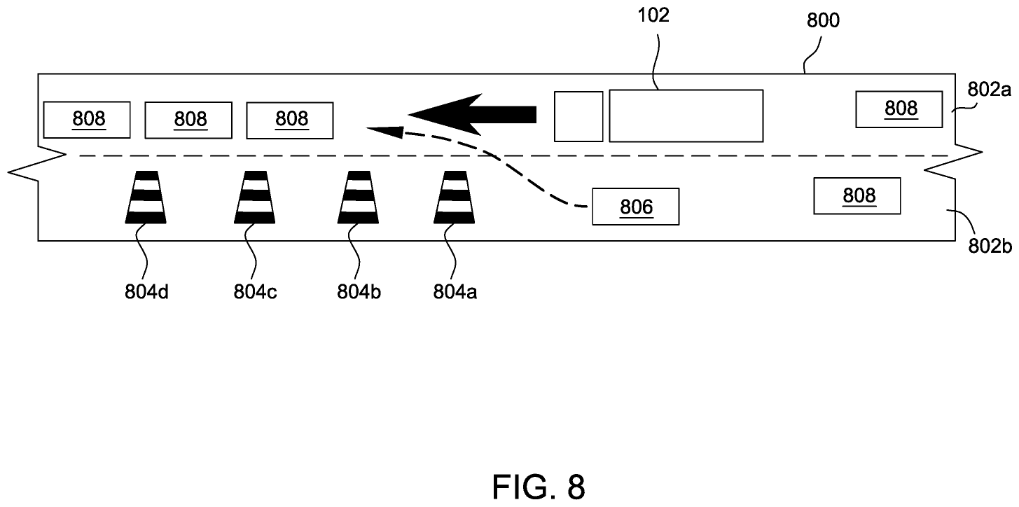

FIG. 8 illustrates a third example case in which movable members 104 may be utilized. In the third example case, AV 102 is traveling on a highway segment 800 having two left-bound lanes 802a, 802b. In the example of FIG. 8, a lane restriction (e.g., cones 804a-804d, debris, or other object(s), a closure, or the like) is present in lane 802b, requiring that traffic merge into one lane 802a. A coexistent vehicle 806 may attempt to inappropriately or unsafely cut off AV 102 at the point of merging. Even if a driver of coexistent vehicle 806 is not intending to cut off AV 102, a stream of several vehicles 808 behaving similarly to coexistent vehicle 806 may prevent AV 102 from advancing through the point of merging. In such situations, AV 102 may extend movable members 104 from a left side of AV 102, which may prevent coexistent vehicle 806 from passing AV 102 on the left after AV 102 has passed the appropriate point of merging or some other predefined point before the vehicles must merge. In some embodiments, AV 102 may, using signaling devices 114, display warning symbols and/or information relating to why the vehicles must merge.

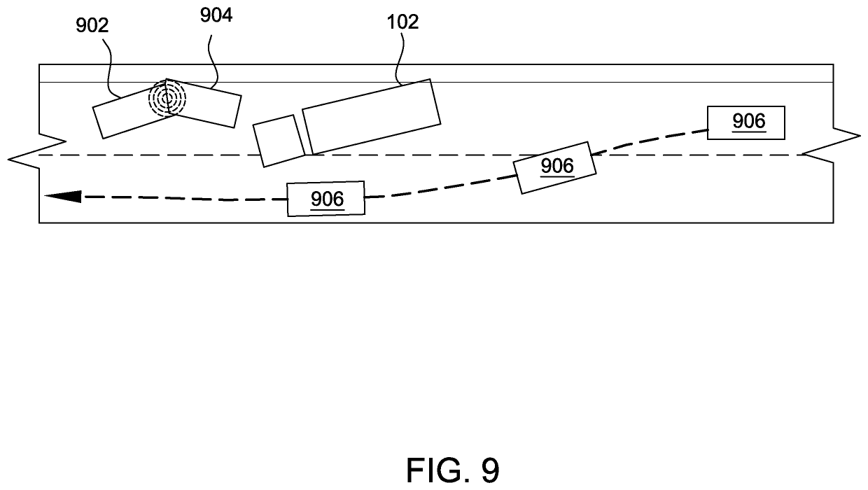

FIG. 9 illustrates a fourth example case in which movable members 104 may be utilized. In the fourth example, a collision has occurred between two vehicles 902 and 904. AV 102 may be deployed to make sure traffic maintains a safe amount of space around vehicles 902 and 904, for example, while emergency responders are traveling to and/or present at the scene of the collision. AV 102 may extend movable members 104 from a left side of AV 102 to prevent passing traffic (e.g., vehicles 906) from traveling too close to vehicles 902 and 904. In some embodiments, AV 102 may, using signaling devices 114, display warning symbols and/or information relating to why the vehicles must merge and/or steer around the scene of the collision.

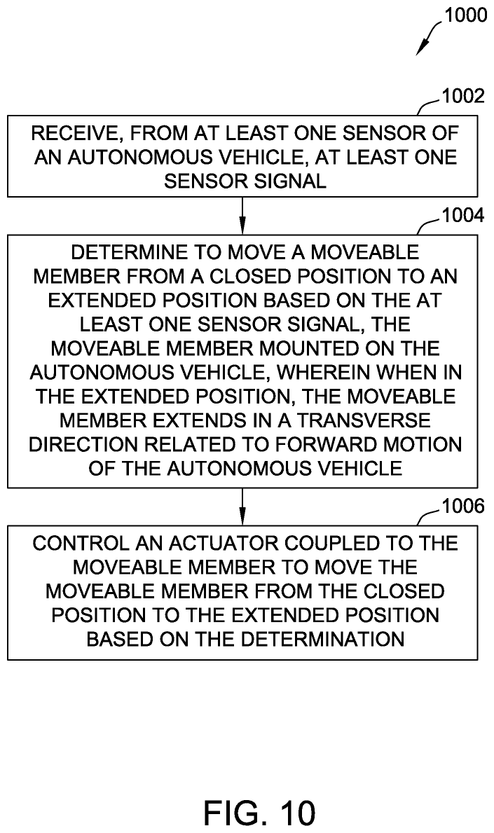

FIG. 10 is a flow chart illustrating an example method for altering form factor of an autonomous vehicle, such as AV 102, which in an example embodiment, is performed by system 100. In the example embodiment, a processing system (such as autonomy computing system 108 or a combination of autonomy computing system 108 and one or more other processors) receives 1002, from at least one sensor 202 of AV 102 at least one sensor signal. In the example embodiment, the processing system determines 1004 to move movable member 104 from a closed position to an extended position based on the at least one sensor signal. When in the extended position, movable member 104 extends in a transverse direction relative to forward motion of the autonomous vehicle (e.g., to increase a combined width of AV 102 and movable members 104). In the example embodiment, the processing system controls 1006 actuator 106 to move movable member 104 from the closed position to the extended position based on the determination.

In some embodiments, the processing system also identifies a vehicle operation (e.g., a turn or lane change) to be performed by the autonomous vehicle. In some such embodiments, the processing system determines whether the identified vehicle operation is associated with extending the movable member (e.g., based on a memory lookup) and determines to move movable member 104 from the closed position to the extended position when AV 102 engaging in the vehicle operation.

In some embodiments, the processing system determines, by applying the at least one sensor signal to one or more predefined rules, whether it is feasible to move movable member 104 from the closed position to the extended position and determines to move movable member 104 from the closed position to the extended position when it is feasible to move movable member 104 from the closed position to the extended position. In some such embodiments, the one or more predefined rules includes a maximum speed threshold, and to determine whether it is feasible to move the movable member from the closed position to the extended position, the processing system compares a current speed of AV 102 to the maximum speed threshold.

In some embodiments, the processing system, when movable member 104 is in the extended position, determines to move movable member 104 from the extended position to the closed position based on the at least one sensor signal and controls actuator 106 to move movable member 104 from the extended position to the closed position.

In some embodiments, movable member 104 includes signaling device 114, which is configured to display one or more display patterns. In some such embodiments, the processing system selects a display pattern of the one or more display patterns based on the at least one sensor signal and causes signaling device 114 to display the selected display pattern.

While described in certain examples as being performed by autonomy computing system 108, at least some aspects of method 1000 may be performed by another controller and/or processor, such as a dedicated controller for movable members 104 separate from AV 102.

An example technical effect of the methods, systems, and apparatus described herein includes at least one of: (a) enabling an AV to safely turn by providing a flap or boom that is automatically extended to prevent other vehicles from passing unsafely close to the AV; (b) enabling an AV to autonomously determine when to extend a flap or boom based on data received from sensors based on a determination of both a current vehicle situation and a physical feasibility of extending the flap or boom; and/or (c) enabling an AV, when extending a flap or boom, to provide information to other vehicles using a signaling device such as an array of individually controlled LEDs.

Some embodiments involve the use of one or more electronic processing or computing devices. As used herein, the terms “processor” and “computer” and related terms, e.g., “processing device” and “computing device” are not limited to just those integrated circuits referred to in the art as a computer, but broadly refers to processors, a processing device, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

In the embodiments described herein, memory may include, but is not limited to, a non-transitory computer-readable medium, such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable, and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for altering form factor of an autonomous vehicle, the system comprising:
a movable member for mounting on the autonomous vehicle, the movable member configured to move between a closed position and an extended position, wherein when in the extended position, the movable member extends in a transverse direction relative to forward motion of the autonomous vehicle;
an actuator coupled to the movable member and configured to move the movable member between the closed position and the extended position;
an processing system in communication with the actuator, the processing system configured to:
receive, from at least one sensor of the autonomous vehicle, at least one sensor signal;
determine to move the movable member from the closed position to the extended position based on the at least one sensor signal; and
control the actuator to move the movable member from the closed position to the extended position based on the determination.

2. The system of claim 1, wherein to determine to move the movable member from the closed position to the extended position, the processing system is further configured to:
determine, by applying the at least one sensor signal to one or more predefined rules, whether it is feasible to move the movable member from the closed position to the extended position; and
determine to move the movable member from the closed position to the extended position when it is feasible to move the movable member from the closed position to the extended position.

3. The system of claim 2, wherein the one or more predefined rules includes a maximum speed threshold, and wherein to determine whether it is feasible to move the movable member from the closed position to the extended position, the processing system is configured to compare a current speed of the autonomous vehicle to the maximum speed threshold.

4. The system of claim 1, wherein the processing system is further configured to identify a vehicle operation to be performed by the autonomous vehicle.

5. The system of claim 4, wherein to determine to move the movable member from the closed position to the extended position, the processing system is further configured to:
determine whether the identified vehicle operation is associated with extending the movable member; and
determine to move the movable member from the closed position to the extended position when the autonomous vehicle is engaging in the vehicle operation.

6. The system of claim 1, wherein the processing system is further configured to:
when the movable member is in the extended position, determine to move the movable member from the extended position to the closed position based on the at least one sensor signal; and
control the actuator to move the movable member from the extended position to the closed position.

7. The system of claim 1, wherein the movable member comprises a signaling device configured to display one or more display patterns.

8. The system of claim 7, wherein the processing system is further configured to:
select a display pattern of the one or more display patterns based on the at least one sensor signal; and
cause the signaling device to display the selected display pattern.

9. The system of claim 7, wherein the signaling device comprises an array of light emitting diodes.

10. The system of claim 1, wherein the movable member comprises one of a flap or a boom.

11. A method for altering form factor of an autonomous vehicle, the method comprising:
receiving, from at least one sensor of the autonomous vehicle, at least one sensor signal;
determining to move a movable member from a closed position to an extended position based on the at least one sensor signal, the movable member mounted on the autonomous vehicle, wherein when in the extended position, the movable member extends in a transverse direction relative to forward motion of the autonomous vehicle; and
controlling an actuator coupled to the movable member to move the movable member from the closed position to the extended position based on the determination.

12. The method of claim 11, determining to move the movable member from the closed position to the extended position comprises:
determining, by applying the at least one sensor signal to one or more predefined rules, whether it is feasible to move the movable member from the closed position to the extended position; and
determining to move the movable member from the closed position to the extended position when it is feasible to move the movable member from the closed position to the extended position.

13. The method of claim 12, wherein the one or more predefined rules includes a maximum speed threshold, and wherein determining whether it is feasible to move the movable member from the closed position to the extended position comprises comparing a current speed of the autonomous vehicle to the maximum speed threshold.

14. The method of claim 11, further comprising identifying a vehicle operation to be performed by the autonomous vehicle.

15. The method of claim 14, wherein determining to move the movable member from the closed position to the extended position comprises:
determining whether the identified vehicle operation is associated with extending the movable member; and
determining to move the movable member from the closed position to the extended position when the autonomous vehicle is engaging in the vehicle operation.

16. The method of claim 11, further comprising:
when the movable member is in the extended position, determining to move the movable member from the extended position to the closed position based on the at least one sensor signal; and
controlling the actuator to move the movable member from the extended position to the closed position.

17. The method of claim 11, wherein the movable member includes a signaling device configured to display one or more display patterns, and wherein the method further comprises:
selecting a display pattern of the one or more display patterns based on the at least one sensor signal; and
causing the signaling device to display the selected display pattern.

18. An processing system for altering form factor of an autonomous vehicle, the processing system comprising a processor configured to:
receive, from at least one sensor of the autonomous vehicle, at least one sensor signal;
determine to move a movable member from a closed position to an extended position based on the at least one sensor signal, the movable member mounted on the autonomous vehicle, wherein when in the extended position, the movable member extends in a transverse direction relative to forward motion of the autonomous vehicle; and
control an actuator in communication with the processing system and coupled to the movable member to move the movable member from the closed position to the extended position based on the determination.

19. The processing system of claim 18, wherein to determine to move the movable member from the closed position to the extended position, processor is further configured to:
determine, by applying the at least one sensor signal to one or more predefined rules, whether it is feasible to move the movable member from the closed position to the extended position; and
determine to move the movable member from the closed position to the extended position when it is feasible to move the movable member from the closed position to the extended position.

20. The processing system of claim 18, wherein the processor is further configured to identify a vehicle operation to be performed by the autonomous vehicle.
